(19) United States
(12) Patent Application Publication
(10) Pub. No.: US 2024/0297822 A1
(43) Pub. Date: Sep. 5, 2024

(54) SYSTEM AND METHOD FOR DESIGN OF A NETWORK SLICE

(71) Applicant: Rakuten Mobile, Inc., Tokyo (JP)

(72) Inventors: Mohit LUTHRA, Singapore (SG); Jithin CHATHANKANDATH, Tokyo (JP)

(21) Appl. No.: 17/999,559

(22) PCT Filed: Sep. 22, 2022
(86) PCT No.: PCT/US2022/044355

§ 371 Date: Nov. 22, 2022

(51) Int. Cl. H04L 41/0895; H04L 41/084; H04L 41/22; H04L 41/5009

(52) U.S. Cl. CPC H04L 41/0895; H04L 41/084; H04L 41/22; H04L 41/5009

(57) ABSTRACT

A method includes receiving a selection of a network slice template from a list of one or more network slice templates; in response to the selection of the network slice template, receiving for input into the network slice template one or more of a network slice name; a network slice type; a network slice domain; a network slice resource sharing level; or a network slice coverage area; and creating, by a processor, a network slice based upon the received input into the network slice template.

### TECHNICAL FIELD

This description relates to a system and method for design of a network slice of using the same.

### BACKGROUND

A cellular network is a telecommunication system of mobile devices (e.g., mobile phone devices) that communicate by radio waves through one or more local antenna at a cellular base station (e.g., cell tower). The coverage area in which service is provided is divided into small geographical areas called cells. Each cell is served by a separate low-power-multichannel transceiver and antenna at the cell tower. Mobile devices within a cell communicate through that cell's antenna on multiple frequencies and on separate frequency channels assigned by the base station from a common pool of frequencies used by the cellular network.

A radio access network (RAN) is part of the telecommunication system and implements radio access technology. RANs reside between a device such as a mobile phone, a computer, or remotely controlled machine and provides connection with a core network (CN). Depending on the standard, mobile phones and other wireless connected devices are varyingly known as user equipment (UE), terminal equipment (TE), mobile station (MS), and the like.

### SUMMARY

In some embodiments, a method includes receiving a selection of a network slice template from a list of one or more network slice templates; in response to the selection of the network slice template, receiving for input into the network slice template one or more of a network slice name; a network slice type; a network slice domain; a network slice resource sharing level; or a network slice coverage area; and creating, by a processor, a network slice based upon the received input into the network slice template.

In some embodiments, an apparatus, includes a processor; and a memory having instructions stored thereon that, when executed by the processor, cause the processor to receive a selection of a network slice template from a list of one or more network slice templates; in response to the selection of the network slice template, receive for input into the network slice template one or more of a network slice name; a network slice type; a network slice domain; a network slice resource sharing level; or a network slice coverage area; and create a network slice based upon the received input into the network slice template.

In some embodiments, a non-transitory computer readable medium having instructions stored thereon that, when executed by a processor, cause the processor to receive a selection of a network slice template from a list of one or more network slice templates; in response to the selection of the network slice template, receive for input into the network slice template one or more of a network slice name; a network slice type; a network slice domain; a network slice resource sharing level; or a network slice coverage area; and create a network slice based upon the received input into the network slice template.

### BRIEF DESCRIPTION OF THE DRAWINGS

Aspects of the present disclosure are understood from the following detailed description when read with the accompanying FIGS. In accordance with the standard practice in the industry, various features are not drawn to scale. In some embodiments, dimensions of the various features are arbitrarily increased or reduced for clarity of discussion.

FIG. 1 is a diagrammatic representation of a system for network slice design (NSD), in accordance with some embodiments.

FIG. 2 is a flow diagram of method for designing a network slice, in accordance with some embodiments.

FIGS. 3-15 are graphic user interfaces (GUIs) for designing a network slice, in accordance with some embodiments.

FIG. 16 is a high-level functional block diagram of a processor-based system, in accordance with some embodiments.

### DETAILED DESCRIPTION

The following disclosure provides many different embodiments, or examples, for implementing distinctive features of the discussed subject matter. Examples of components, values, operations, materials, arrangements, or the like, are described below to simplify the present disclosure. These are, of course, examples and are unintended to be limiting. Other components, values, operations, materials, arrangements, or the like, are contemplated. For example, the formation of a first feature over or on a second feature in the description that follows include embodiments in which the first and second features are formed in direct contact, and further include embodiments in which additional features are formed between the first and second features, such that the first and second features are unable to be in direct contact. In addition, the present disclosure repeats reference numerals and/or letters in the numerous examples. This repetition is for the purpose of simplicity and clarity and is unintended to dictate a relationship between the various embodiments and/or configurations discussed.

Further, spatially relative terms, such as beneath, below, lower, above, upper and the like, are used herein for ease of description to describe one element or feature's relationship to another element(s) or feature(s) as illustrated in the FIGS. The spatially relative terms are intended to encompass different orientations of the device in use or operation in addition to the orientation depicted in the FIGS. The apparatus is otherwise oriented (rotated 90 degrees or at other orientations) and the spatially relative descriptors used herein likewise are interpreted accordingly.

In some embodiments, a network slice design is created through graphical user interfaces (GUIs) on a user interface (UI) in accordance with examples of the present disclosure.

Network slicing (or 5G network slicing) is a network architecture that enables the multiplexing of virtualized and independent logical networks on the same physical network infrastructure. Each network slice is an isolated end-to-end (E2E) network tailored to fulfil diverse requirements requested by a particular application. For this reason, this technology assumes a leading role to support 5G mobile networks that are designed to efficiently handle a plethora of services with very different service level requirements (SLR). The realization of this service-oriented view of the network leverages on the concepts of software-defined networking (SDN) and network function virtualization (NFV) that allow the implementation of flexible and scalable network slices on top of a common network infrastructure. Each network slice is administrated by a mobile virtual network operator (MVNO). The infrastructure provider (the owner of the telecommunication infrastructure) leases physical resources to the MVNOs that share the underlying physical network. According to the availability of the assigned resources, a MVNO autonomously deploys multiple network slices that are customized to the various applications provided to its own users. In some embodiments, the MVNO and infrastructure provider are one in the same; that is a service provider. In some embodiments, the service provider is the MVNO.

A UI is the space where interactions between humans and machines occur. The goal of this interaction is to allow effective operation and control of a machine from the human end, while the machine simultaneously feeds back information that aids the operators' decision-making process. Examples include the interactive aspects of computer operating systems, hand tools, heavy machinery operator controls, and process controls. UIs include one or more layers, including a human-machine interface (HMI) that interfaces machines with physical input hardware such as keyboards, mice, or game pads, and output hardware such as computer monitors, speakers, and printers. A device that implements an HMI is called a human interface device (HID). Other terms for human-machine interfaces are man-machine interface (MMI) and, when the machine in question is a computer, human-computer interface. Additional UI layers may interact with one or more human senses, including: tactile UI (touch), visual UI (sight), auditory UI (sound), olfactory UI (smell), equilibria UI (balance), and gustatory UI (taste).

The GUI is a form of user interface that allows users to interact with electronic devices through graphical icons and audio indicators such as primary notation, instead of text-based UIs, typed command labels, or text navigation. The actions in a GUI are usually performed through direct manipulation of the graphical elements. GUIs are used in many handheld mobile devices such as MP3 players, portable media players, gaming devices, smartphones and smaller household, office, and industrial controls.

In other approaches E2E network slice design includes several steps and is labor intensive through manual design. In some embodiments, E2E network slice design is made more efficient through GUIs manipulated by a user on a UI. In some embodiments, the UI provides the user the ability to choose various related aspects of network slice design. In some embodiments, GUIs are configured to design an E2E slice through a UI, the ability to choose slice design parameters from the UI, and the ability to monitor the status of a network slice from a GUI.

The E2E principle is a design framework in computer networking. In networks designed according to this principle, guaranteeing certain application-specific features, such as reliability and security, implements these features in the communicating end nodes of the network. Intermediary nodes, such as gateways and routers, which exist to establish the network, may implement these to improve efficiency but cannot guarantee end-to-end correctness.

Network slice design is still a new concept. In some embodiments, network slice design operations based on a GUI are discussed. These operations include a user inputting information such as, network slice name, slice type (eMBB (enhanced mobile broadband) providing faster connections, higher throughput, and more capacity for areas of higher traffic such as stadiums, cities, and concert venues or mIoT (massive Internet of thing) slice), domains (such as RAN, core, and transport), shared or non-shared slice selection, public land mobile network (PLMN) ID of the slice, and coverage area for the slice. Other operations include defining a slice such as, service profile parameters (such as latency, data-rate, and mobility-level) requested by a northbound interface (e.g., internal to the system or manually from a user) and conversion of service profile parameters to slice profile parameters (holds the slice sub-net parameter info of different network domain slice subnet instances (NSSIs), such as RAN, transport network (TN), and CN NSSI. Other examples of service profile parameters include acceptable latency, number of UEs to be connected, and download and upload throughput expected from a slice. In some embodiments, in response to the service profile parameters being inputted and a user clicks on a user input field configured to divide the service profile requirements into slice profile parameters. In some embodiments, a slice profile parameters is what is expected from each domain (e.g., such as the latency expected from a RAN domain).

A northbound interface of a component is an interface that allows the component to communicate with a higher-level component, using the latter component's southbound interface. The northbound interface conceptualizes the lower-level details (e.g., data or functions) used by, or in, the component, allowing the component to interface with higher level layers. The northbound interface is normally drawn at the top of the component it is defined in. A southbound interface decomposes concepts in the technical details, mostly specific to a single component of the architecture. Southbound interfaces are drawn at the bottom of an architectural overview.

In some embodiments, a user inputs a slice subnet profile through a GUI. The slice subnet profile includes the domain (such as RAN, CN, or TN) specific subnet (a segmented piece of a larger network). A slice manager (a centralized software component that provides an interface for creating, modifying, monitoring, and deleting slices) makes application programming interface (API is a type of software interface, offering a service to other pieces of software) calls to an orchestrator (allows an SDN controller—via APIs—to provision, update and manage the computing resources required to deliver an application or service) and fetches information of available subnets of each domain based on whether the subnet is shared or dedicated. A shared subnet is an already deployed subnet, which is shared with other network slices. A dedicated subnet is new subnet deployed for a dedicated slice.

In some embodiments, a user, through a GUI, determines network slice feasibility, such as whether the selected subnets are feasible to be deployed. In a non-limiting example, in the event of a shared subnet, there is a maximum number of slices supported. Thus, part of the feasibility check is to determine whether a shared subnet has exceeded the number of slices supported.

In some embodiments, the user determines compliance with service level agreements (SLAs) once the slice is deployed. For example, a user, through a GUI, establishes parameters or key performance indicators (KPIs) of slices that are to be monitored, and the user selects a policy for automated slice healing use-cases (e.g., upon detection of one or more network faults, the system's diagnostics automatically reconfigure the communications path to maintain system communications).

In some embodiments, the user, through a GUI, previews and submits a designed network slice. Further, the user selects the network slice to preview and submit from a list of designed slices. In some embodiments, the user deploys the slice through point and click (moving a pointer to a certain location on a screen (pointing) and then pressing a button on a mouse, usually the left button) and deploy the completed slice. In a non-limiting example, the slice manager makes API calls for the orchestrator to deploy the slices.

In some embodiments, a user opens a slice design UI and opens a list of slice templates available. The user selects a slice template and clicks on a create a new slice user selection field based on the slice template. Slice designing begins and the user inputs information such as, type of slice. For example, is the slice eMBB, ultra-reliable low-latency communications (URLLC for short-packet data transmission used to meet both reliability and latency requirements), or massive machine-type communications (mMTC used to connect to a large number of devices such as Internet of things (IOT) devices) type of slice. The user further selects shared or dedicated slice subnets for each domain (RAN, CN or TN) and coverage area of the network slice.

In some embodiments, the user moves to a slice definition page where service profile SLA parameters are displayed from the slice template. In some embodiments, the user modifies the parameters, such as latency, from the UI. Once the user confirms the service profile parameters for a complete E2E network slice, the user points and clicks on a calculate user selection button and the slice manager calculates the slice profile parameters of each domain (RAN, CN, and TN) to meet service profile SLAs. In a non-limiting example, in response to an SLA service profile latency of 10 ms (e.g., the SLA states the latency is to be at or under 10 ms), the service profile is potentially mapped to 3 ms from RAN, 3 ms from CN and 4 ms from the TN domain for a total of 10 ms.

In some embodiments, the user navigates to a slice subnet profile UI page, where the user selects an already deployed domain specific network service (in response to that domain being shared) or a network service template (in response to that domain being dedicated and a new network service is being deployed for this subnet). In response to the selections, the user points and clicks on a feasibility user selection button to determine whether selected network services are ready to serve the new network slice.

In some embodiments, the user navigates to a SLAs GUI, where the user selects which SLAs parameters are to be monitored for a given slice. The user then previews the SLAs parameters for the given slice and submits the network slice for design. In response to submission, a network slice is designed and is displayed on the network slice lifecycle management (LCM) GUI. In some embodiments, the user navigates to an LCM slice GUI and selects the designed slice to deploy the designed slice.

In some embodiments, the slice manager starts deploying each domain of the designed slice and the status of deployment is displayed on the GUI. Further, when the slice is deployed the status is updated on the GUI (e.g., from inactive to active).

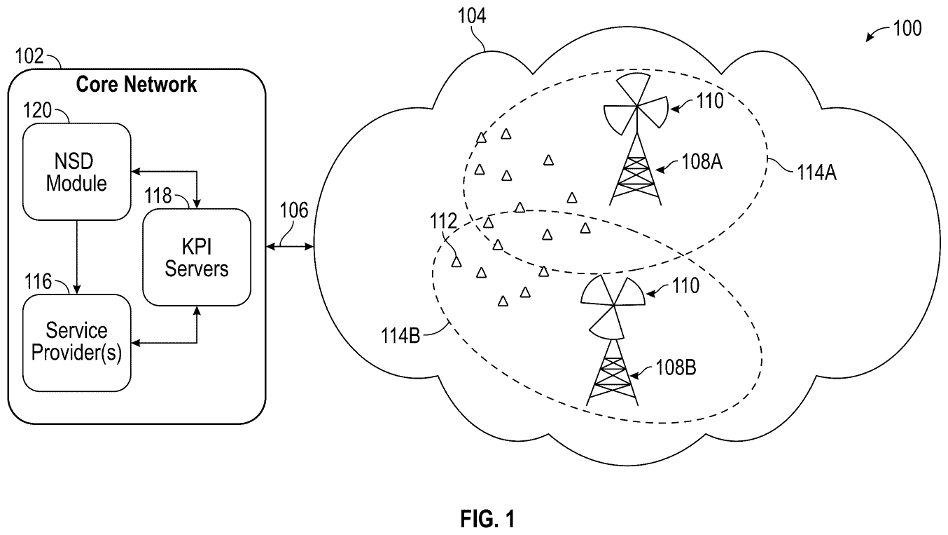

FIG. 1 is a diagrammatic representation of a system for network slice design (NSD) 100, in accordance with some embodiments.

NSD system 100 includes a CN 102 communicatively connected to RAN 104 through TN 106, which is communicatively connected to base stations 108A and 108B (hereinafter base station 108), with antennas 110 that are wirelessly connected to UEs 112 located in geographic coverage cells 114A and 114B (hereinafter geographic coverage cells 114). CN 102 includes one or more service provider(s) 116, KPI servers 118, and NSD module 120.

CN 102 (further known as a backbone) is a part of a computer network which interconnects networks, providing a path for the exchange of information between different local area networks (LANs) or subnetworks. In some embodiments, CN 102 ties together diverse networks over wide geographic areas, in different buildings in a campus environment, or in the same building.

In some embodiments, RAN 104 is a global system for mobile communications (GSM) RAN, a GSM/EDGE RAN, a universal mobile telecommunications system (UMTS) RAN (UTRAN), an evolved UMTS terrestrial radio access network (E-UTRAN), open RAN (O-RAN), or cloud-RAN (C-RAN). RAN 104 resides between UE 112 (e.g., mobile phone, a computer, or any remotely controlled machine) and CN 102. In some embodiments, RAN 104 is a C-RAN for purposes of simplified representation and discussion. In some embodiments, base band units (BBU) replace the C-RAN.

In conventional distributed cellular networks, equipment at the bottom and top of a base station of a cell site is the BBU. The BBU is radio equipment that links UEs to the CN and processes billions of bits of information per hour. The BBU was traditionally placed in an enclosure or shelter situated at the bottom of a base station. C-RAN, in contrast, uses fiber optic's large signal-carrying capacity to centralize numerous BBUs at a dedicated pool location or a base station. This reduces the quantity of equipment at base stations and provides many other advantages, including lower latency.

In a hierarchical telecommunications network, TN 106 of NSD system 100 includes the intermediate link(s) between CN 102 and RAN 104. The two main methods of mobile backhaul implementations are fiber-based backhaul and wireless point-to-point backhaul. Other methods, such as copper-based wireline, satellite communications and point-to-multipoint wireless technologies are being phased out as capacity and latency requirements become higher in 4G and 5G networks. Backhaul refers to the side of the network that communicates with the Internet. The connection between base station 108 and UE 112 begins with TN 106 connected to CN 102. In some embodiments, TN 106 includes wired, fiber optic, and wireless components. Wireless sections include using microwave bands, mesh, and edge network topologies that use high-capacity wireless channels to get packets to the microwave or fiber links.

In some embodiments, base stations 108 are lattice or self-supported towers, guyed towers, monopole towers, and concealed towers (e.g., towers designed to resemble trees, cacti, water towers, signs, light standards, and other types of structures). In some embodiments, base stations 108 are a cellular-enabled mobile device site where antennas and electronic communications equipment are placed, typically on a radio mast, tower, or other raised structure to create a cell (or adjacent cells) in a network. The raised structure typically supports antenna(s) 110 and one or more sets of transmitter/receivers (transceivers), digital signal processors, control electronics, a remote radio head (RRH), primary and backup electrical power sources, and sheltering. Base stations are known by other names such as base transceiver station, mobile phone mast, or cell tower. In some embodiments, base stations are replaced with other edge devices configured to wirelessly communicate with UEs. The edge device provides an entry point into service provider CNs, such as CN 102. Examples include routers, routing switches, integrated access devices (IADs), multiplexers, and a variety of metropolitan area network (MAN) and wide area network (WAN) access devices.

In at least one embodiment, antenna(s) 110 are a sector antenna. In some embodiments, antenna(s) 110 are a type of directional microwave antenna with a sector-shaped radiation pattern. In some embodiments, the sector degrees of arc are 60°, 90°, or 120° designs with a few degrees extra to ensure overlap. Further, sector antennas are mounted in multiples when wider coverage or a full-circle coverage is desired. In some embodiments, antenna(s) 110 are a rectangular antenna, sometimes called a panel antenna or radio antenna, used to transmit and receive waves or data between mobile devices or other devices and a base station. In some embodiments, antenna(s) 110 are circular antennas. In some embodiments, antenna 110 operates at microwave or ultra-high frequency (UHF) frequencies (300 MHz to 3 GHz). In other examples, antenna(s) 110 are chosen for their size and directional properties. In some embodiments, the antenna(s) 110 are MIMO (multiple-input, multiple-output) antennas that send and receive greater than one data signal simultaneously over the same radio channel by exploiting multipath propagation.

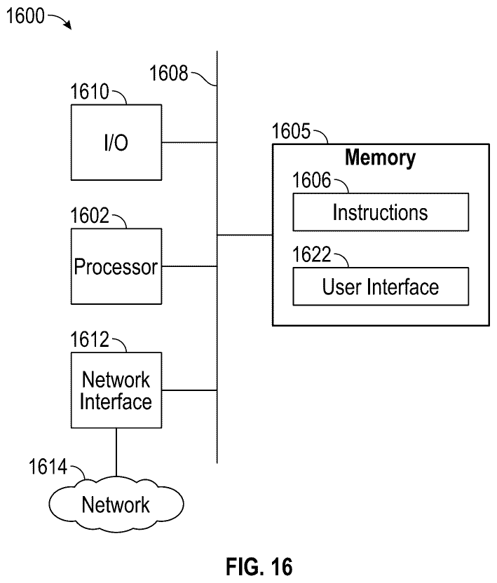

In some embodiments, UEs 112 are a computer or computing system. Additionally, or alternatively, UEs 112 have a liquid crystal display (LCD), light-emitting diode (LED) or organic light-emitting diode (OLED) screen interface, such as user interface (UI) 1622 (FIG. 16), providing a touchscreen interface with digital buttons and keyboard or physical buttons along with a physical keyboard. In some embodiments, UE 112 connects to the Internet and interconnects with other devices. Additionally, or alternatively, UE 112 incorporates integrated cameras, the ability to place and receive voice and video telephone calls, video games, and Global Positioning System (GPS) capabilities. Additionally, or alternatively, UEs run operating systems (OS) that allow third-party apps specialized for capabilities to be installed and run. In some embodiments, UEs 112 are a computer (such as a tablet computer, netbook, digital media player, digital assistant, graphing calculator, handheld game console, handheld personal computer (PC), laptop, mobile Internet device (MID), personal digital assistant (PDA), pocket calculator, portable medial player, or ultra-mobile PC), a mobile phone (such as a camera phone, feature phone, smartphone, or phablet), a digital camera (such as a digital camcorder, or digital still camera (DSC), digital video camera (DVC), or front-facing camera), a pager, a personal navigation device (PND), a wearable computer (such as a calculator watch, smartwatch, head-mounted display, earphones, or biometric device), or a smart card.

In some embodiments, geographic coverage cells 114 include a shape and size. In some embodiments, geographic coverage cells 114 are a macro-cell (covering 1 Km-30 Km), a micro-cell (covering 200 m-2 Km), or a pico-cell (covering 4 m-200 m). In some embodiments, geographic coverage cells are circular, oval (FIG. 1), sector, or lobed in shape, but geographic coverage cells 114 are configured in most any shape or size. Geographic coverage cells 114 represent the geographic area antenna 110 and UEs 112 are configured to communicate. Coverage depends on several factors, such as orography (i.e., mountains) and buildings, technology, radio frequency and most importantly for two-way telecommunications the sensitivity and transmit efficiency of UE 112. Some frequencies provide better regional coverage, while other frequencies penetrate better through obstacles, such as buildings in cities. The ability of a UE to connect to a base station depends on the strength of the signal.

Service provider(s) 116 are businesses, vendors, customers, or organizations that sell bandwidth or network access to subscribers (utilizing UEs) by providing direct Internet backbone access to Internet service providers and usually access to network access points (NAPs). Service providers are sometimes referred to as backbone providers, Internet providers, or vendors. Service providers include telecommunications companies, data carriers, wireless communications providers, Internet service providers, and cable television operators offering high-speed Internet access.

KPI servers 118 produce both predictions and live network data. Live-network data (KPIs, UE/cell/MDT (minimization of drive test) traces, and crowdsourced data) that allows for modelling of network traffic, hot-spot identification, and radio signal propagation. RF drive testing is a method of measuring and assessing the coverage, capacity, and Quality of Service (QOS) of a mobile radio network, such as RAN 104. The technique consists of using a motor vehicle containing mobile radio network air interface measurement equipment that detects and records a wide variety of the physical and virtual parameters of mobile cellular service in each geographical area. By measuring what a wireless network subscriber experiences in an area, wireless carriers make directed changes to networks that provide better coverage and service to customers. Drive testing commonly is configured with a mobile vehicle outfitted with drive testing measurement equipment. The equipment is usually highly specialized electronic devices that interface to original equipment manufacturer (OEM) mobile handsets (UEs). This ensures measurements are realistic and comparable to actual user experiences. For mobile networks, crowdsourcing methodology leverages a crowd of participants (e.g., the mobile subscribers) to gather network measurements, either manually or automatically through mobile apps, or directly from the network using call traces.

UE/cell/MDT traces collected at the operations support systems (OSS) or through dedicated tools provide service provider(s) 116 with user-level information. Once geo-located, UE/cell/MDT traces are used to enhance path-loss calculations and prediction plots, as well as to identify and locate problem areas and traffic hotspots. KPI servers 118 allow service provider(s) 116 to use UE/cell/MDT traces along with NSD module 120 for network optimization.

In some embodiments, NSD module 120 is configured to allow a user to design one or more network slices. In some embodiments, the network slice design is GUI based. In some embodiments, operations include a user inputting information such as, network slice name, slice type (eMBB (enhanced mobile broadband) providing faster connections, higher throughput, and more capacity for areas of higher traffic such as stadiums, cities, and concert venues or mIoT (massive Internet of thing) slice), domains (such as RAN, core, and transport), and shared or non-shared slice selection, public land mobile network (PLMN) ID of the slice, and coverage area for the slice. Other operations include defining a slice such as, service profile parameters (holds the original requirement of communication-service-instance, such as latency, data-rate, and mobility-level) requested by a northbound interface (e.g., internal to the system or manually from a user) and conversion of service profile parameters to slice profile parameters (holds the slice sub-net parameter info of different network domain slice subnet instances (NSSIs), such as RAN, transport network (TN), and CN NSSI.

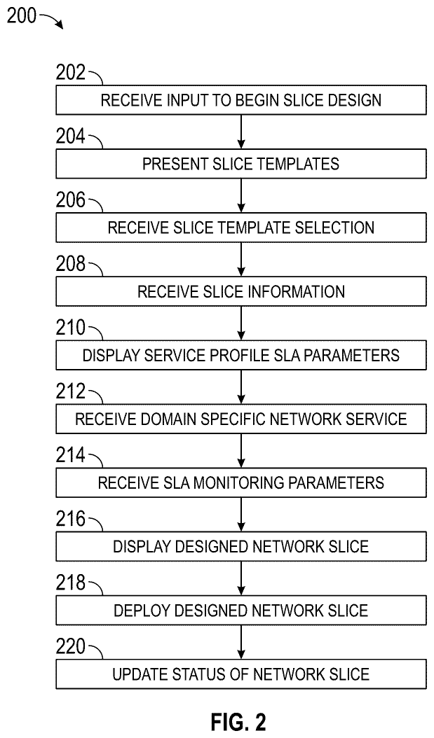

FIG. 2 is a flow diagram for a method of designing a network slice 200, in accordance with some embodiments.

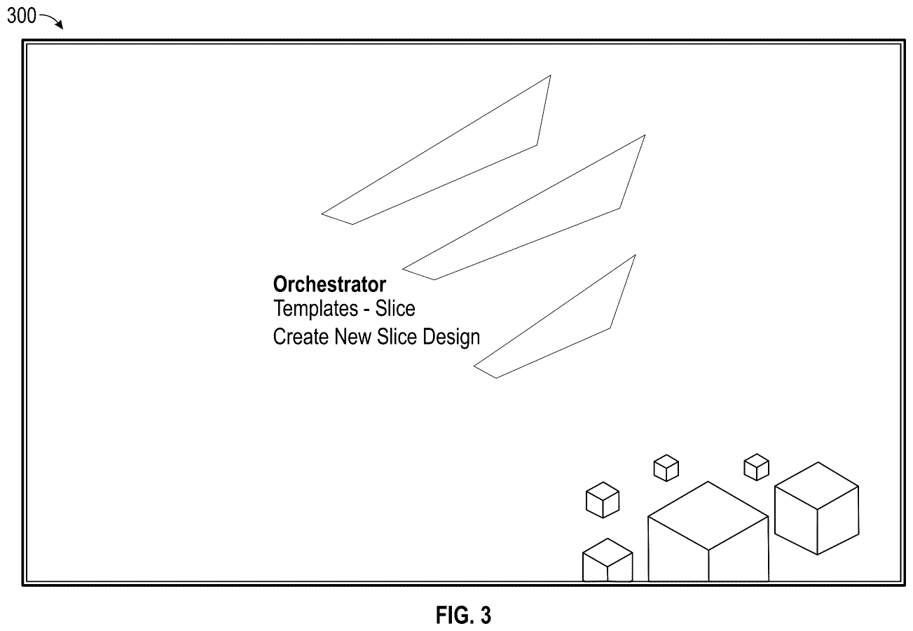

FIGS. 3-15 are graphic user interfaces (GUIs) 300-1500 for designing a network slice, in accordance with some embodiments.

In some embodiments, NSD method 200 describes process tasks of network slice design. While the operations of NSD method 200 are discussed and shown as having a particular order, each operation in NSD method 200 is configured to be performed in any order unless specifically called out otherwise. NSD method 200 is implemented as a set of operations, such as operations 202 through 220. Further, NSD method 200 is discussed with reference to FIGS. 3-15 to assist in the understanding of NSD method 200.

At operation 202 of NSD method 200, NSD module 120 receives an input from a user to begin network slice design. In some embodiments, the user is presented with GUI 300 indicating a network slice design application is starting. Process flows from operation 202 to operation 204.

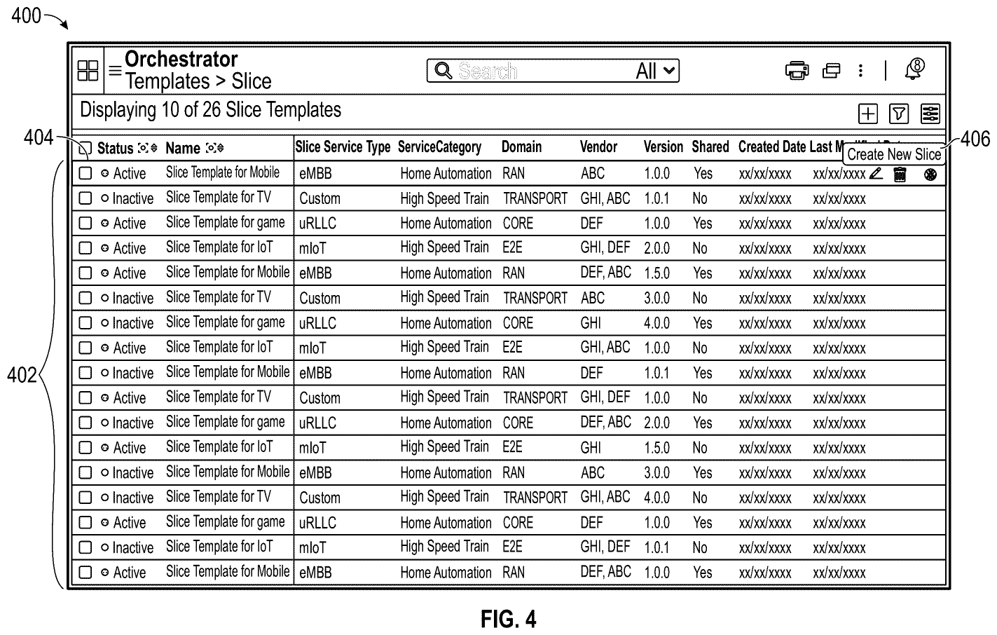

At operation 204 of NSD method 200, NSD module 120 presents a list of slice templates. In FIG. 4, GUI 400 displays slice template list 402. In some embodiments, each network slice in slice template list 402 includes a status (e.g., active, or inactive), a name, a slice service type (e.g., eMBB, uRLLC, mIoT, or custom), a service category (such as home automation, high speed train, etc.), a domain (RAN, TN, CN, or E2E), a vendor, version, shared (or not), created date, and last modified date. The term template refers to a common feature of a software application that defines a unique non-executable file format intended specifically for that application Process flows from operation 204 to operation 206.

At operation 206 of NSD method 200, NSD module 120 receives a user input indicating a selection of a slice template. In FIG. 4, a user points to a slice template, for example slice template 404, then clicks on the slice template. Create new slice user selection button 406 pops up and the user clicks on user selection button 406 to begin the process of creating a new slice with the selected slice template. Process flows from operation 206 to operation 208.

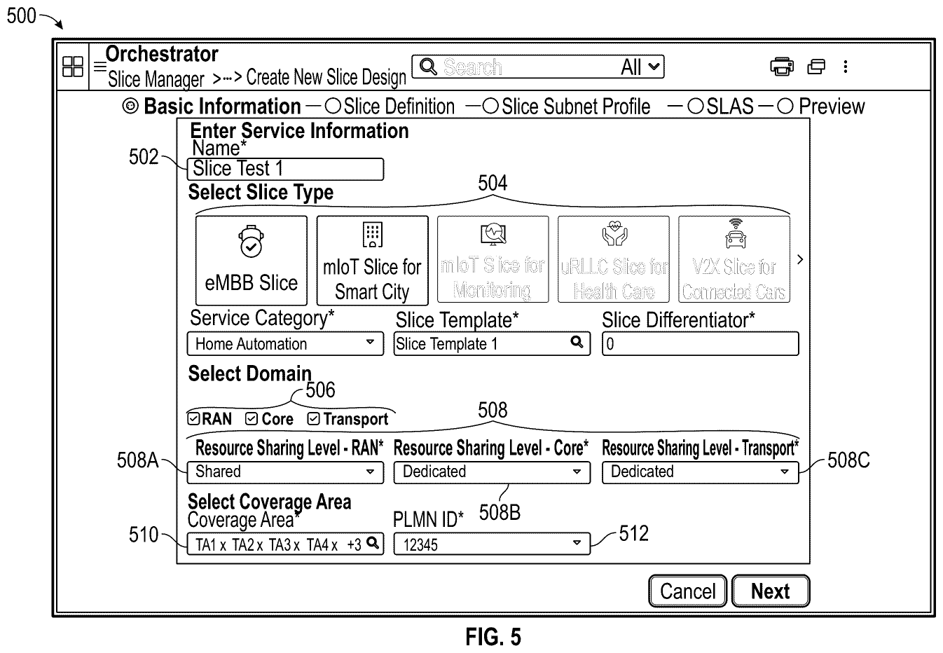

At operation 208 of NSD method 200, GUI 500 is presented, and the user inputs slice information. In FIG. 5, a user inputs a slice name in user input field 502, selects a slice type from user selection field 504 (e.g., eMBB or URLLC type of slice), selects domains from user selection field 506, and selects whether the slice is shared or dedicated from user selection field 508. For example, the user selects a shared or dedicated slice subnet for each domain (RAN at user selection field 508A, core at user selection field 508B or transport at user selection field 508C) and coverage area of the network slice at user selection field 510. Process flows from operation 208 to operation 210.

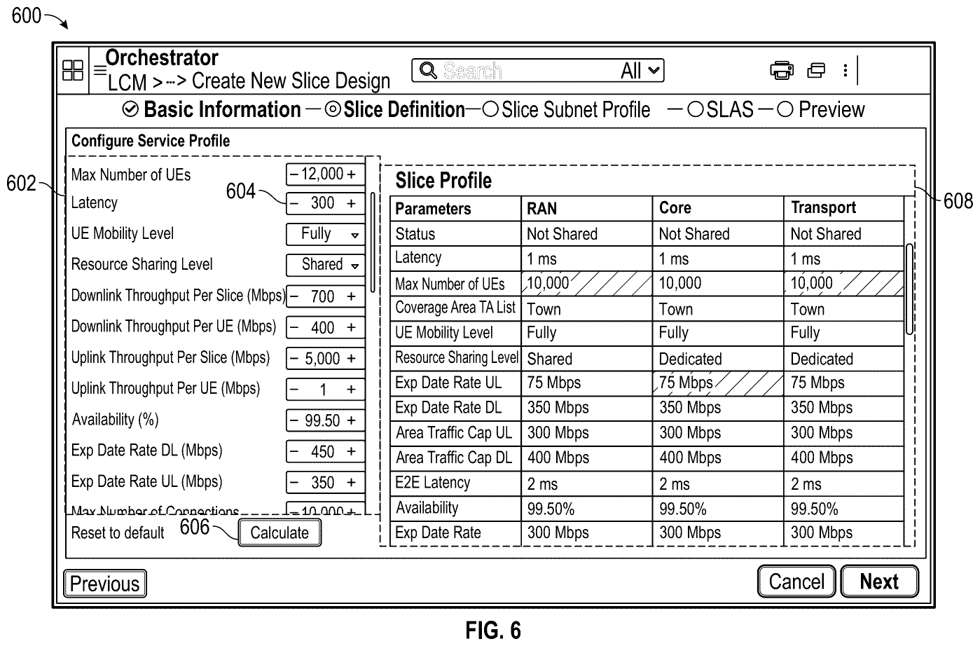

At operation 210 of NSD method 200, GUI 600 is presented, and the user sets network slice parameters. In FIG. 6, at slice parameter GUI 600, service profile SLA parameters 602 are presented and configured so the user modifies the parameters as applicable. In a non-limiting example, a user modifies an expected latency to fit the specifications of the network slice at user selection field 604 (e.g., set at 300 ms). Once the user confirms all service profile parameters within parameter field 602, for complete end to end network slice, the user points and clicks on calculate user selection button 606. The slice manager calculates slice profile parameters (shown in slice profile box 608) of each domain (RAN, CORE, and transport) to meet service profile SLAs. Process flows from operation 210 to operation 212.

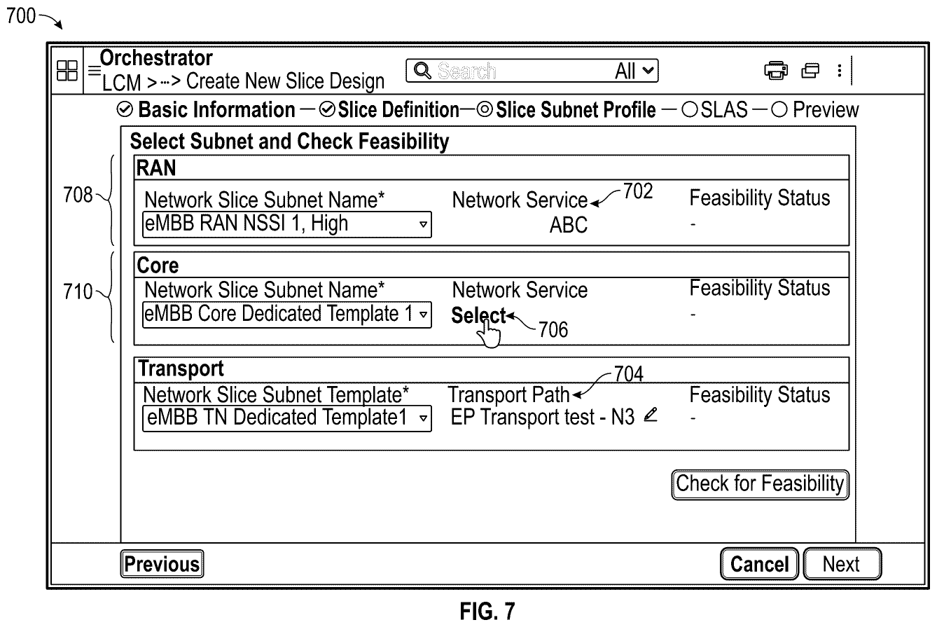

At operation 212 of NSD method 200, GUI 700 is presented, and the user selects a subnet profile, such as an already deployed domain specific network service (a shared network service or a dedicated network service). In FIG. 7, the user navigates to slice subnet profile GUI 700, where the user selects one of an already deployed domain specific network service (e.g., network service 702 and 704 where the domain is shared) or a network service template (where the domain is dedicated) by pointing and clicking on select user selection field 706. In a non-limiting example, in response to a network slice subnet for RAN domain 708 being shared, then the already deployed network slice subnet is capable of being obtained and selected for use. In some embodiments, network services are selected for a network slice subnet. Continuing with the non-limiting example, a network service for a RAN domain, such as ABC, is an identifier of the network service from the RAN domain which is deployed. Continuing with the non-limiting example, at core domain 710, the user is able to select the template name by clicking on user selection field 706 as a new network service is being deployed for CORE domain 710.

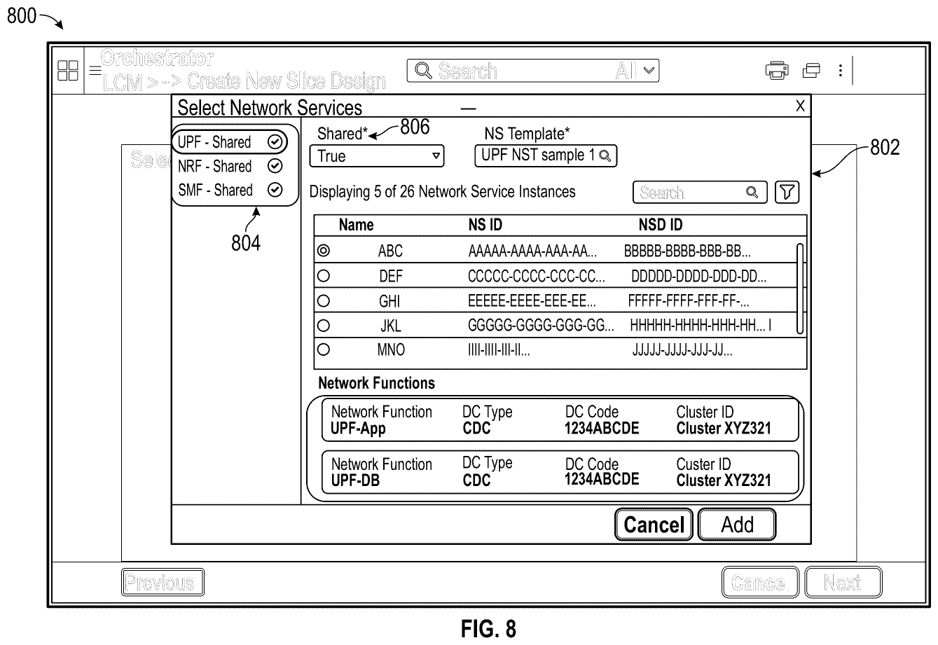

In FIG. 8, GUI 800 is presented after the user clicks on select user selection field 706, and the user is presented with a select network services pop-up box 802. As shown in box 804, each of the network services, such as user plane function (UPF is responsible for packet routing and forwarding, packet inspection, quality of service (QoS) handling, and external protocol data unit (PDU) session for interconnecting data network (DN) in a 5G architecture), network repository function (NRF acts as a central services discovery broker for all network functions (NFs) in the 5G Core), or session management function (SMF is responsible for interacting with the decoupled data plane, creating updating and removing PDU sessions and managing session context with the UPF). In a non-limiting example, a user selects UPF (shown as highlighted) and within shared user input field 806 a user is presented with an indication (e.g., true) that the UPF network service is shared.

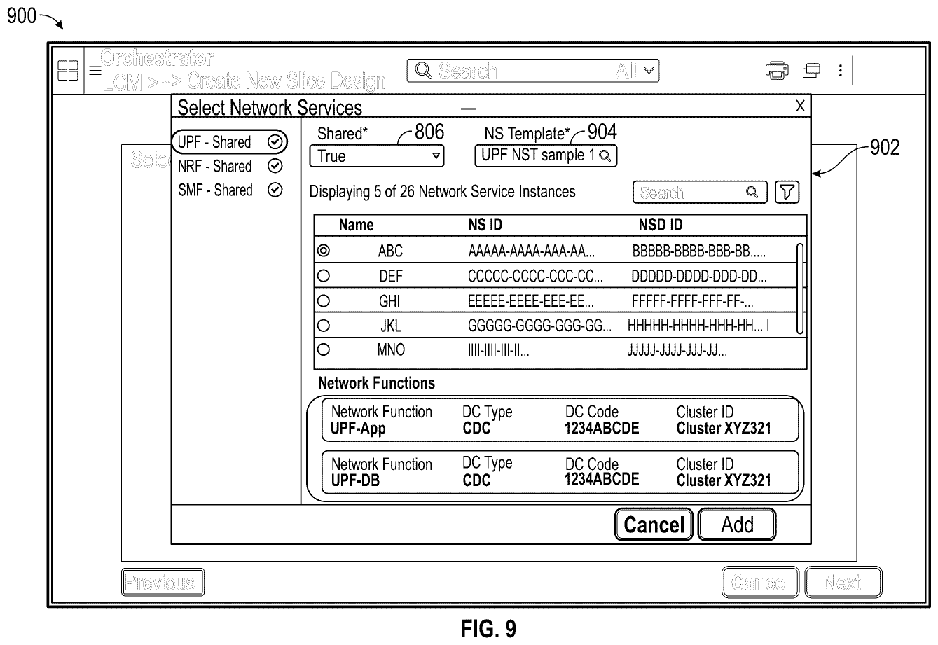

Alternatively, in FIG. 9, GUI 900 displays NRF as highlighted and false being presented within shared user input field 806 indicating the NRF network service is not shared. Thus, a user fills out template 902 for a dedicated network service. The user selects a network services template in NS template user selection field 904. In response to selection of a network service template (e.g., UPF NST sample 2), the user is presented with network functions to select from.

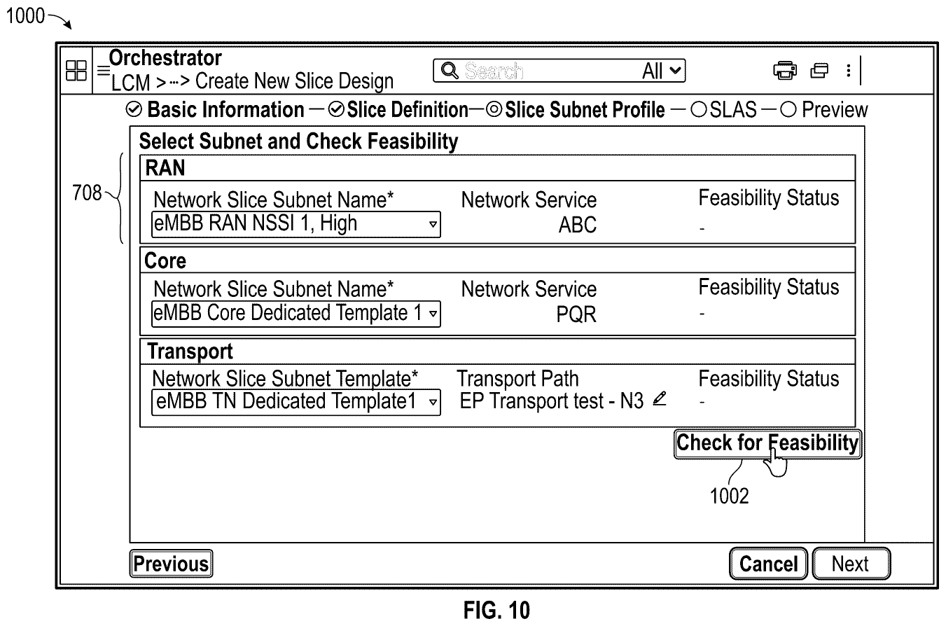

In FIG. 10, GUI 1000 is presented after each of the domains (RAN, core, and transport) include a network service. Once each domain includes a network service, the user points and clicks on feasibility user selection field 1002 and NSD module 120 determines whether the selected network services are ready to serve the new network slice. In some embodiments, in response to the user clicks on feasibility user selection field 1002, NSD module 120 determines whether the selected subnets are feasible to be deployed as part of new network slice (e.g., in a shared subnet, there is a maximum number of slices one subnet supports or whether a new core network service is deployable).

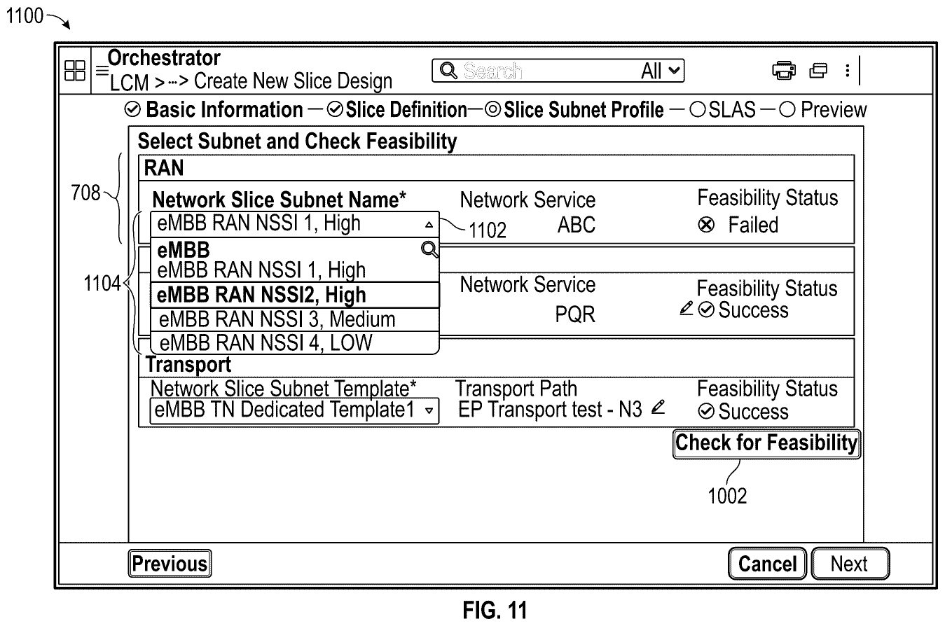

In FIG. 11, GUI 1100 is presented when the feasibility test fails for one or more domains (e.g., the RAN domain). The user clicks on network slice subnet name user selection field 1102 to select another slice subnet and recheck the feasibility by clicking on feasibility user selection field 1002. In a non-limiting example, in FIG. 11 the feasibility for RAN domain 708 is failed, meaning, the selected network service is unsupported in the new network slice, so a user is able to click on user selection field 1102 and select a different RAN subnet from list 1104 is chosen and a feasibility test is rerun.

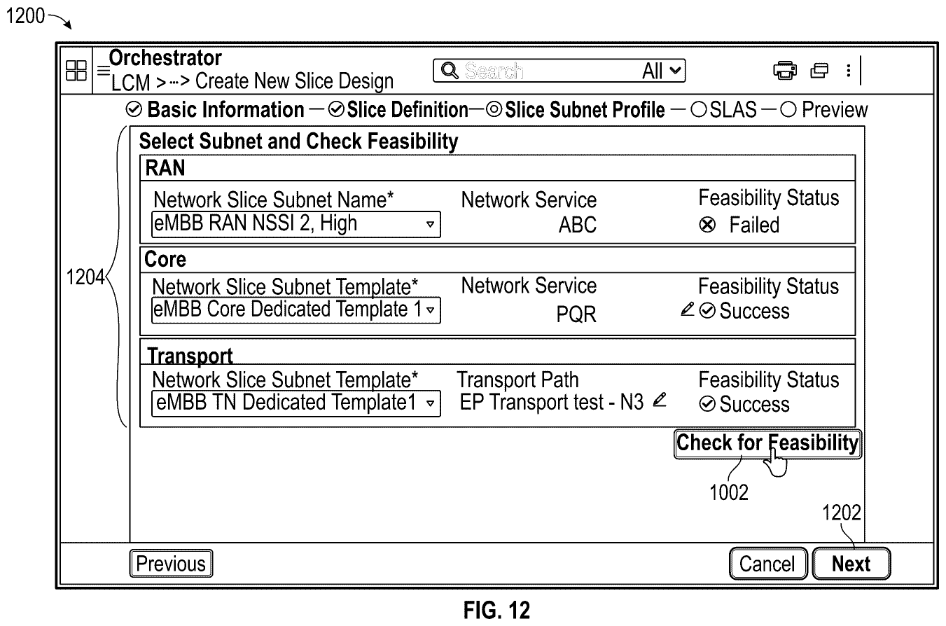

In FIG. 12, GUI 1200 is presented when the feasibility test is successful for each domain. The user clicks next user selection button 1202 to deploy the network slice. Process flows from operation 212 to operation 214. In the non-limiting example, in response to a check for feasibility being successful, a network slice is able to be created by using the selected respective domain subnets 1204.

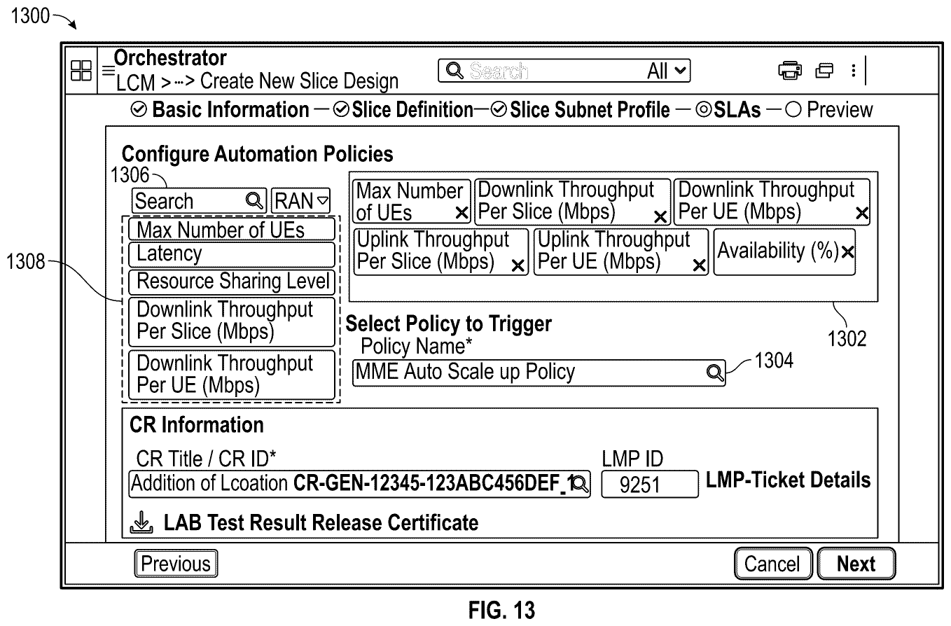

At operation 214 of method 200, GUI 1300 is presented (FIG. 13), and the user selects SLA parameters, such as parameters, shown in parameter box 1302, to be monitored for the slice. A user searches from parameters within search user input field 1306 for a selected domain. In some embodiments, the user drags and drops parameters/KPIs 1308 to parameter box 1302. Further, in response to the slice being deployed and the selection of parameters or KPIs (box 1302) to be monitored, the user selects a policy, from policy name user selection field 1304 for slice automated healing use-cases. Auto healing is a function that automatically detects disabled access points and restores the wireless network (e.g., by increasing the coverage area created by nearby access points, restarting network functions, or the like). Process flows from operation 214 to operation 216.

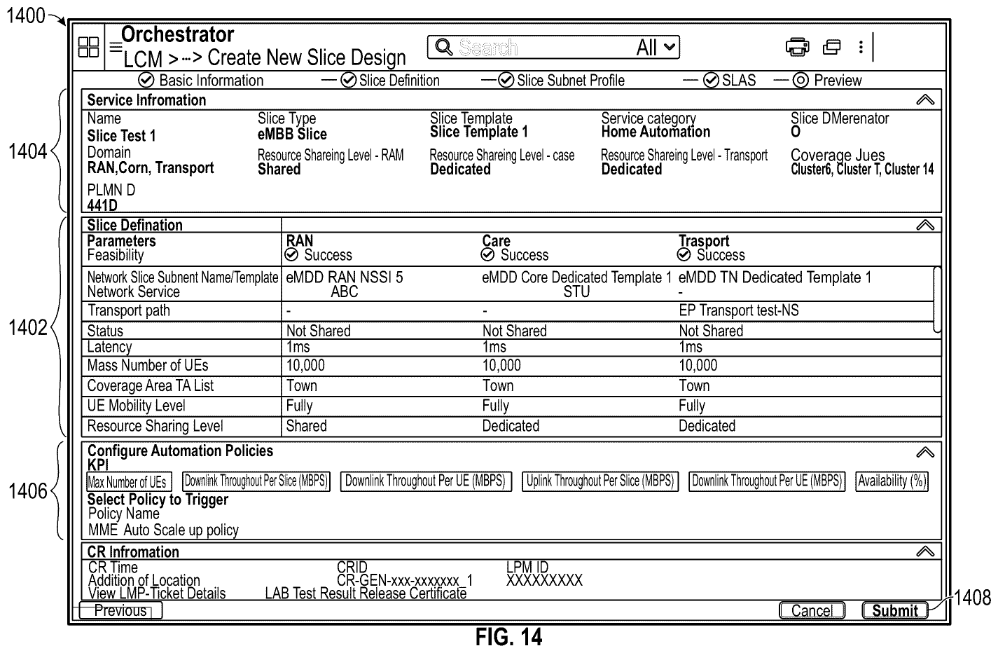

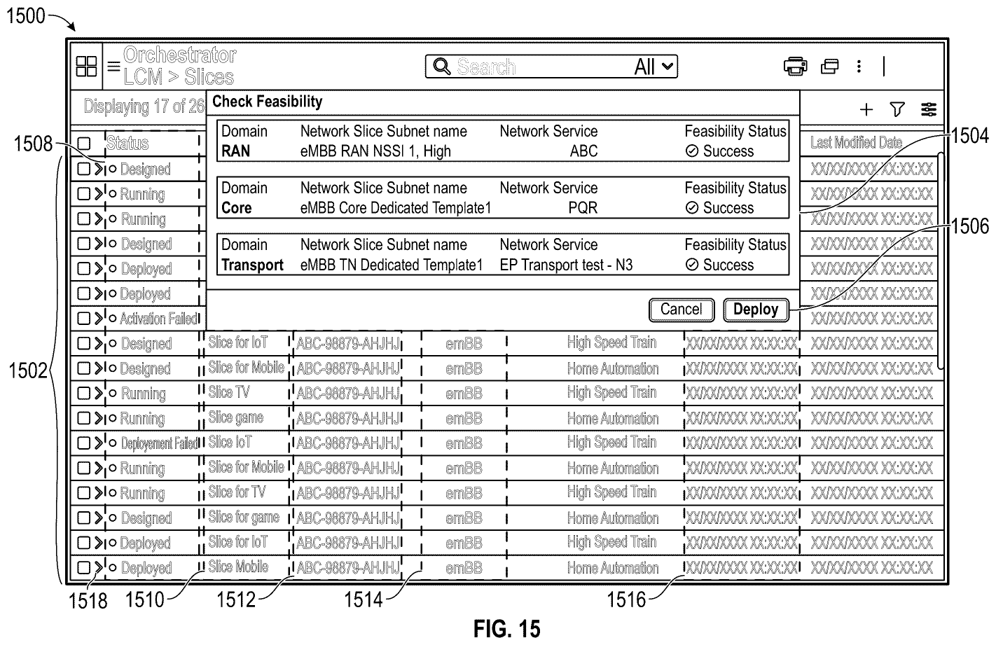

At operation 216 of method 200, designed network slice 1402 is displayed on GUI 1400 (FIG. 14) for the user's review. After previewing network slice 1402, including service information 1404 and automation policies 1406, the user clicks on submit user selection field 1408 after a determination the information is correct. In response to submit user selection field 1408 being clicked, GUI 1500 (FIG. 15) is displayed with a list of network slices 1502. In some embodiments, in response to a user clicking on submit user selection field 1408, network slice 1402 from GUI 1400 is designed and listed on a GUI 1500 (FIG. 15) displayed with a list of network slices 1502. Process flows from operation 216 to operation 218.

At operation 218 of method 200, a user deploys the designed network sliced by clicking on the desired network slice in list of network slices 1502, which displays pop up box 1504 of GUI 1500. The user clicks on deploy user selection button 1506 to deploy the designed slice. In some embodiments, the slice manager (not shown) makes an API call to the orchestrator (not shown) and the designed slice is deployed. Process flows from operation 218 to operation 220.

At operation 220 of method 200, the status of the designed slice is updated. As seen in status column 1508, the status of the network slice is updated from designed to deployed. Other statuses include running, activation failed, deployment failed. In some embodiments, in response to a slice being submitted successfully and listed, the slice is labeled as “Designed”. GUI 1500 captures the status of the slice in status column 1508, slice name column 1510, generated slice ID column 1512, slice service type column 1514, slice creation date column 1516, and other suitable slice details within the scope of the embodiments.

In some embodiments, a user is able to click on carrot user selection field 1518, which rotates and exposes a table with the subnet details of the slice (such as NSSI status, NSSI, and the domain). In some embodiments, in response to the user deploying the slice, a slice manager (not shown) again performs a feasibility check to determine whether space is available for the network slice subnets.

FIG. 16 is a block diagram of network slice design (NSD) processing circuitry 1600 in accordance with some embodiments. In some embodiments, NSD processing circuitry 1600 is a general-purpose computing device including a hardware processor 1602 and a non-transitory, computer-readable storage medium 1604. Storage medium 1604, amongst other things, is encoded with, i.e., stores, computer program code 1606, i.e., a set of executable instructions such as an algorithm, or method 200. Execution of instructions 1606 by hardware processor 1602 represents (at least in part) a network slice design application which implements a portion, or all the methods described herein in accordance with one or more embodiments (hereinafter, the noted processes and/or methods).

Processor 1602 is electrically coupled to a computer-readable storage medium 1604 via a bus 1608. Processor 1602 is further electrically coupled to an I/O interface 1610 by bus 1608. A network interface 1612 is further electrically connected to processor 1602 via bus 1608. Network interface 1612 is connected to a network 1614, so that processor 1602 and computer-readable storage medium 1604 connect to external elements via network 1614. Processor 1602 is configured to execute computer program code 1606 encoded in computer-readable storage medium 1604 to cause NSD processing circuitry 1600 to be usable for performing a portion or all the noted processes and/or methods. In one or more embodiments, processor 1602 is a central processing unit (CPU), a multi-processor, a distributed processing system, an application specific integrated circuit (ASIC), and/or a suitable processing unit.

In one or more embodiments, computer-readable storage medium 1604 is an electronic, magnetic, optical, electromagnetic, infrared, and/or a semiconductor system (or apparatus or device). For example, computer-readable storage medium 1604 includes a semiconductor or solid-state memory, a magnetic tape, a removable computer diskette, a random-access memory (RAM), a read-only memory (ROM), a rigid magnetic disk, and/or an optical disk. In one or more embodiments using optical disks, computer-readable storage medium 1604 includes a compact disk-read only memory (CD-ROM), a compact disk-read/write (CD-R/W), and/or a digital video disc (DVD).

In one or more embodiments, storage medium 1604 stores computer program code 1606 configured to cause NSD processing circuitry 1600 to be usable for performing a portion or all the noted processes and/or methods. In one or more embodiments, storage medium 1604 further stores information, such as a mitigation algorithm which facilitates performing a portion or all the noted processes and/or methods.

NSD processing circuitry 1600 includes I/O interface 1610. I/O interface 1610 is coupled to external circuitry. In one or more embodiments, I/O interface 1610 includes a keyboard, keypad, mouse, trackball, trackpad, touchscreen, and/or cursor direction keys for communicating information and commands to processor 1602.

NSD processing circuitry 1600 further includes network interface 1612 coupled to processor 1602. Network interface 1612 allows NSD processing circuitry 1600 to communicate with network 1614, to which one or more other computer systems are connected. Network interface 1612 includes wireless network interfaces such as BLUETOOTH, WIFI, WIMAX, GPRS, or WCDMA; or wired network interfaces such as ETHERNET, USB, or IEEE-864. In one or more embodiments, a portion or all noted processes and/or methods, is implemented in two or more NSD processing circuitry 1600.

NSD processing circuitry 1600 is configured to receive information through I/O interface 1610. The information received through I/O interface 1610 includes one or more of instructions, data, design rules, and/or other parameters for processing by processor 1602. The information is transferred to processor 1602 via bus 1608. NSD processing circuitry 1600 is configured to receive information related to UI 1622 through I/O interface 1610. The information is stored in computer-readable medium 1604 as user interface (UI) 1622.

In some embodiments, a portion or all the noted processes and/or methods is implemented as a standalone software application for execution by a processor. In some embodiments, a portion or all the noted processes and/or methods is implemented as a software application that is a part of an additional software application. In some embodiments, a portion or all the noted processes and/or methods is implemented as a plug-in to a software application.

In some embodiments, the processes are realized as functions of a program stored in a non-transitory computer readable recording medium. Examples of a non-transitory computer-readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

In some embodiments, a method includes receiving a selection of a network slice template from a list of one or more network slice templates; in response to the selection of the network slice template, receiving for input into the network slice template one or more of a network slice name; a network slice type; a network slice domain; a network slice resource sharing level; or a network slice coverage area; and creating, by a processor, a network slice based upon the received input into the network slice template.

In some embodiments, the method further includes causing, by the processor, a graphical user interface (GUI) to be output by a user interface (UI), the GUI including the list of one or more network slice templates configured to design a network slice; updating the GUI, the GUI comprising: a create new slice user input field; and in response to the selection of the network slice template from the list of one or more network slice templates, updating the GUI, the GUI configured to receive for input into the network slice template one or more of a first user input field configured to receive the network slice name; a second user input field configured to receive the network slice type; a third user input field configured to receive the network slice domain; a fourth user input field configured to receive the network slice resource sharing level; or a fifth user input field configured to receive the network slice coverage area.

In some embodiments, the method further includes in response to receiving a user input for one or more of the first through fifth user input field, updating the GUI, the GUI including one or more user selection fields configured to be modified to design a network slice service profile, where each user selection field represents a modifiable domain parameter.

In some embodiments, the method further includes converting each modifiable domain parameter for each network slice domain identified in the third user input field to a slice profile parameter.

In some embodiments, the method further includes in response to the conversion of each modifiable domain parameter for each network slice domain identified in the third user input field to the slice profile parameter, updating the GUI, the GUI including one or more network slice subnet user selection fields configured to allow a user to select a domain specific subnet.

In some embodiments, each network slice subnet user selection field contains subnets determined to be available for each domain.

In some embodiments, the method further includes in response to the selection of the domain specific subnet for each domain, determining whether one or more user selected domain specific subnets are capable of deployment.

In some embodiments, the method further includes in response to the selection of the domain specific subnets, updating the GUI, the GUI including a list of parameters of key performance indicators (KPIs) that are configured to be selected by a user, each parameter or KPI to be monitored upon deployment of the network slice.

In some embodiments, the GUI further including a sixth user selection field configured to allow the user to select an automated healing policy for detected faults.

In some embodiments, the method further includes deploying the network slice.

In some embodiments, an apparatus, includes a processor; and a memory having instructions stored thereon that, when executed by the processor, cause the processor to receive a selection of a network slice template from a list of one or more network slice templates; in response to the selection of the network slice template, receive for input into the network slice template one or more of a network slice name; a network slice type; a network slice domain; a network slice resource sharing level; or a network slice coverage area; and create a network slice based upon the received input into the network slice template.

In some embodiments, the instructions further cause the processor to cause a graphical user interface (GUI) to be output by a user interface (UI), the GUI including the list of one or more network slice templates configured to design a network slice; update the GUI, the GUI including a create new slice user input field; and in response to the create new slice user input field being selected by a user, update the GUI, the GUI including a first user input field configured to receive the network slice name; a second user input field configured to receive the network slice type; a third user input field configured to receive the network slice domain; a fourth user input field configured to receive the network slice resource sharing level; and a fifth user input field configured to receive the network slice coverage area.

In some embodiments, the instructions further cause the processor to in response to receiving a user input for one or more of the first through fifth user input field, update the GUI, the GUI including one or more user selection fields configured to be modified to design a network slice service profile, where each user selection field represents a modifiable domain parameter.

In some embodiments, the instructions further cause the processor to convert each modifiable domain parameter for each network slice domain identified in the third user input field to a slice profile parameter.

In some embodiments, the instructions further cause the processor to in response to the conversion of each modifiable domain parameter for each network slice domain identified in the third user input field to the slice profile parameter, update the GUI, the GUI including one or more network slice subnet user selection fields configured to allow a user to select a domain specific subnet.

In some embodiments, a non-transitory computer readable medium having instructions stored thereon that, when executed by a processor, cause the processor to receive a selection of a network slice template from a list of one or more network slice templates; in response to the selection of the network slice template, receive for input into the network slice template one or more of a network slice name; a network slice type; a network slice domain; a network slice resource sharing level; or a network slice coverage area; and create a network slice based upon the received input into the network slice template.

In some embodiments, the instructions further cause the processor to cause a graphical user interface (GUI) to be output by a user interface (UI), the GUI including the list of one or more network slice templates configured to design a network slice; update the GUI, the GUI including a create new slice user input field; and in response to the create new slice user input field being selected by a user, update the GUI, the GUI including a first user input field configured to receive the network slice name; a second user input field configured to receive the network slice type; a third user input field configured to receive the network slice domain; a fourth user input field configured to receive the network slice resource sharing level; and a fifth user input field configured to receive the network slice coverage area.

In some embodiments, the instructions further cause the processor to in response to receiving a user input for one or more of the first through fifth user input field, update the GUI, the GUI including one or more user selection fields configured to be modified to design a network slice service profile, where each user selection field represents a modifiable domain parameter.

In some embodiments, the instructions further cause the processor to convert each modifiable domain parameter for each network slice domain identified in the third user input field to a slice profile parameter.

In some embodiments, the instructions further cause the processor to in response to the conversion of each modifiable domain parameter for each network slice domain identified in the third user input field to the slice profile parameter, update the GUI, the GUI including one or more network slice subnet user selection fields configured to allow a user to select a domain specific subnet.

The foregoing outlines features of several embodiments so that those skilled in the art better understand the aspects of the present disclosure. Those skilled in the art should appreciate that they readily use the present disclosure as a basis for designing or modifying other processes and structures for conducting the same purposes and/or achieving the same advantages of the embodiments introduced herein. Those skilled in the art should further realize that such equivalent constructions do not depart from the spirit and scope of the present disclosure, and that they make various changes, substitutions, and alterations herein without departing from the spirit and scope of the present disclosure.

What is claimed is:

1. A method comprising:
receiving a selection of a network slice template from a list of one or more network slice templates;
in response to the selection of the network slice template, receiving for input into the network slice template one or more of:
a network slice name;
a network slice type;
a network slice domain;
a network slice resource sharing level; or a network slice coverage area; and
creating, by a processor, a network slice based upon the received input into the network slice template.

2. The method of claim 1, further comprising:
causing, by the processor, a graphical user interface (GUI) to be output by a user interface (UI), the GUI comprising:
the list of one or more network slice templates configured to design a network slice;
updating the GUI, the GUI comprising:
a create new slice user input field; and
in response to the selection of the network slice template from the list of one or more network slice templates, updating the GUI, the GUI configured to receive for input into the network slice template one or more of:
a first user input field configured to receive the network slice name;
a second user input field configured to receive the network slice type;
a third user input field configured to receive the network slice domain;
a fourth user input field configured to receive the network slice resource sharing level; or
a fifth user input field configured to receive the network slice coverage area.

3. The method of claim 2, further comprising:
in response to receiving a user input for one or more of the first through fifth user input field, updating the GUI, the GUI comprising:
one or more user selection fields configured to be modified to design a network slice service profile, where each user selection field represents a modifiable domain parameter.

4. The method of claim 3, further comprising:
converting each modifiable domain parameter for each network slice domain identified in the third user input field to a slice profile parameter.

5. The method of claim 4, further comprising:
in response to the conversion of each modifiable domain parameter for each network slice domain identified in the third user input field to the slice profile parameter, updating the GUI, the GUI comprising:
one or more network slice subnet user selection fields configured to allow a user to select a domain specific subnet.

6. The method of claim 5, wherein:
each network slice subnet user selection field contains subnets determined to be available for each domain.

7. The method of claim 5, further comprising:
in response to the selection of the domain specific subnet for each domain, determining whether one or more user selected domain specific subnets are capable of deployment.

8. The method of claim 7, further comprising:
in response to the selection of the domain specific subnets, updating the GUI, the GUI comprising:
a list of parameters of key performance indicators (KPIs) that are configured to be selected by a user, each parameter or KPI to be monitored upon deployment of the network slice.

9. The method of claim 8, wherein the GUI further comprising:
a sixth user selection field configured to allow the user to select an automated healing policy for detected faults.

10. The method of claim 1, further comprising:
deploying the network slice.

11. An apparatus, comprising:
a processor; and
a memory having instructions stored thereon that, when executed by the processor, cause the processor to:
receive a selection of a network slice template from a list of one or more network slice templates;
in response to the selection of the network slice template, receive for input into the network slice template one or more of:
a network slice name;
a network slice type;
a network slice domain;
a network slice resource sharing level; or
a network slice coverage area; and
create a network slice based upon the received input into the network slice template.

12. The apparatus of claim 11, wherein the instructions further cause the processor to:
cause a graphical user interface (GUI) to be output by a user interface (UI), the GUI comprising:
the list of one or more network slice templates configured to design a network slice;
update the GUI, the GUI comprising:
a create new slice user input field; and
in response to the create new slice user input field being selected by a user, update the GUI, the GUI comprising:
a first user input field configured to receive the network slice name;
a second user input field configured to receive the network slice type;
a third user input field configured to receive the network slice domain;
a fourth user input field configured to receive the network slice resource sharing level; and
a fifth user input field configured to receive the network slice coverage area.

13. The apparatus of claim 12, wherein the instructions further cause the processor to:
in response to receiving a user input for one or more of the first through fifth user input field, update the GUI, the GUI comprising:
one or more user selection fields configured to be modified to design a network slice service profile, where each user selection field represents a modifiable domain parameter.

14. The apparatus of claim 13, wherein the instructions further cause the processor to:
convert each modifiable domain parameter for each network slice domain identified in the third user input field to a slice profile parameter.

15. The apparatus of claim 14, wherein the instructions further cause the processor to:
in response to the conversion of each modifiable domain parameter for each network slice domain identified in the third user input field to the slice profile parameter, update the GUI, the GUI comprising:
one or more network slice subnet user selection fields configured to allow a user to select a domain specific subnet.

16. A non-transitory computer readable medium having instructions stored thereon that, when executed by a processor, cause the processor to:
receive a selection of a network slice template from a list of one or more network slice templates;
in response to the selection of the network slice template, receive for input into the network slice template one or more of:
a network slice name;
a network slice type;
a network slice domain;
a network slice resource sharing level; or
a network slice coverage area; and
create a network slice based upon the received input into the network slice template.

17. The non-transitory computer readable medium of claim 16, wherein the instructions further cause the processor to:
cause a graphical user interface (GUI) to be output by a user interface (UI), the GUI comprising:
the list of one or more network slice templates configured to design a network slice;
update the GUI, the GUI comprising:
a create new slice user input field; and
in response to the create new slice user input field being selected by a user, update the GUI, the GUI comprising:
a first user input field configured to receive the network slice name;
a second user input field configured to receive the network slice type;
a third user input field configured to receive the network slice domain;
a fourth user input field configured to receive the network slice resource sharing level; and
a fifth user input field configured to receive the network slice coverage area.

18. The non-transitory computer readable medium of claim 17, wherein the instructions further cause the processor to:
in response to receiving a user input for one or more of the first through fifth user input field, update the GUI, the GUI comprising:
one or more user selection fields configured to be modified to design a network slice service profile, where each user selection field represents a modifiable domain parameter.

19. The non-transitory computer readable medium of claim 18, wherein the instructions further cause the processor to:
convert each modifiable domain parameter for each network slice domain identified in the third user input field to a slice profile parameter.

20. The non-transitory computer readable medium of claim 19, wherein the instructions further cause the processor to:
in response to the conversion of each modifiable domain parameter for each network slice domain identified in the third user input field to the slice profile parameter, update the GUI, the GUI comprising:
one or more network slice subnet user selection fields configured to allow a user to select a domain specific subnet.
